(19) United States
(12) Patent Application Publication
(10) Pub. No.: US 2021/0129572 A1
(43) Pub. Date: May 6, 2021

(54) RADIATIVE EMBOSSING

(71) Applicant: Hewlett-Packard Development Company, L.P., Spring, TX (US)

(72) Inventors: Adam Weisman, San Diego, CA (US); Beverly CHOU, San Diego, CA (US); Or BRANDSTEIN, San Diego, CA (US)

(73) Assignee: Hewlett-Packard Development Company, L.P., Spring, TX (US)

(21) Appl. No.: 17/050,491

(22) PCT Filed: Jun. 15, 2018
(86) PCT No.: PCT/US2018/037804

§ 371 Date: Oct. 26, 2020

(51) Int. Cl. B41M 7/00; C09D 11/38; B41M 5/36; C09D 11/32; B41M 5/52

(52) U.S. Cl. CPC B41M 7/0054; C09D 11/38; B41M 5/5254; C09D 11/32; B41M 5/36

(57) ABSTRACT

The present disclosure is drawn to methods of radiative embossing print media. In one example, the method of radiative embossing a print medium can include printing a radiation absorbing ink on a coated print medium to form a printed area. The coated print medium can include a print substrate and an expanding coating layer on the print substrate. The expanding coating layer can include a thermal expansion agent having a minimum expansion temperature. The method can further include heating the coated print medium using a heater such that the printed area and unprinted area reach a first temperature from 5° C. to 90° C. below the minimum expansion temperature. The coated print medium can be irradiated with radiation having a wavelength from 200 nm to 400 nm to selectively heat the print area and expand the thermal expansion agent in the printed area.

### BACKGROUND

The tactile and visual appearance of textured or embossed media can enhance the value of printed graphics in many industries, such as home decor, signage, scrapbooking, brochures, and so on. Textured and embossed printing media is often made using a stamp, plate, or similar mechanical device. For example, a piece of media such as a sheet of paper can be placed between a positive embossing plate and a negative embossing plate. Pressure can then be applied to the embossing plates to press an embossed pattern into the paper. In another method, paper can be rolled between a positive embossing roller and a negative embossing roller. Similar methods can be used to form fine textures in paper. Such methods can often have a high up-front cost of making the embossing or textured rollers or plates. Making embossed or texture rollers or plates can also be time consuming, so that these methods are often relegated to applications where a large quantity of textured or embossed media is to be made with a single textured or embossed design.

### BRIEF DESCRIPTION OF THE DRAWINGS

FIG. 1 is a flowchart of a method of embossing a print medium, in accordance with an example of the present disclosure;

FIG. 2 is a schematic view of an example coated print medium with a radiation absorbing ink printed on the coated print medium and a heater heating the coated print medium in accordance with an example of the present disclosure;

FIG. 3 is a schematic view of an example coated print medium being embossed by irradiating the coated print medium in accordance with an example of the present disclosure;

FIG. 4 is a schematic view of another example coated print medium having a radiation absorbing ink printed on a back surface and a colored ink printed on a front surface and a heater heating the coated print medium in accordance with an example of the present disclosure;

FIG. 5 is a schematic view of an example coated print medium being embossed by irradiating the coated print medium in accordance with an example of the present disclosure;

FIG. 6 is a schematic view of yet another example coated print medium in accordance with an example of the present disclosure;

FIG. 7 is a schematic view of another example coated print medium in accordance with an example of the present disclosure;

FIG. 8 is a schematic view of an example printing system in accordance with an example of the present disclosure; and

FIG. 9 is a schematic view of an example printer in accordance with an example of the present disclosure.

### DETAILED DESCRIPTION

The present disclosure is drawn to methods of embossing print media, printers, and printing systems for embossing print media. In one example, a method of embossing a print medium can include printing a radiation absorbing ink on the coated print medium to form a printed area. The coated print medium can include a print substrate and an expanding coating layer on the print substrate. The expanding coating layer can include a thermal expansion agent having a minimum expansion temperature. The coated print medium can be heated using a heater such that the printed area and unprinted area reach a first temperature from 5° C. to 90° C. below the minimum expansion temperature. The coated print medium can be irradiated with radiation having a wavelength from 200 nm to 400 nm to selectively heat the printed area and expand the thermal expansion agent in the printed area. In a particular example, the coated print medium can also include an ink receiving layer on the expanding coating layer.

In certain examples, the radiation absorbing ink can include an absorbing agent including a cyan colorant, a magenta colorant, a yellow colorant, bisoctrizole, avobenzone, bisdisulizole disodium, diethylamino hydroxybenzoyl hexyl benzoate, a benzotriazole, a benzophenone, a triazine, or combinations thereof.

In further examples, the expanding coating layer can further include a flexible polymer binder and thermal expansion agent can include temperature responsive thermoplastic beads in the flexible polymeric binder. The temperature responsive thermoplastic beads can include a propellant encapsulated in a thermoplastic polymer shell. In some examples, the thermoplastic polymer shell can have a glass transition temperature from 90° C. to 200° C. In other examples, the flexible polymeric binder can have a glass transition temperature below the glass transition temperature of the thermoplastic polymer shell. In still further examples, the glass transition temperature of the flexible polymeric binder can be from −40° C. to 120° C. In certain examples, the flexible polymeric binder can include styrene butadiene latex, acrylic latex, or a polymer comprising polymerized monomers including vinyl chloride, vinylidene chloride, acrylonitrile, methacrylonitrile, methyl methacrylate, styrene, o-chlorostyrene, vinyl acetate, butyl acrylate, esters of acrylic acid, esters of methacrylic acid, or combinations thereof. In further examples, the propellant can be a liquid having a boiling point from 90° C. to 200° C. In still further examples, the propellants can include methane, ethane, propane, isobutane, n-butane, isooctane, and isopentane, or combinations thereof.

In another example, the radiation absorbing ink can be printed on a first surface of the coated print medium. The first surface can be irradiated with the radiation having a wavelength from 200 nm to 400 nm to expand the thermal expansion agent in the printed area. A visible image can also be printed on an opposite surface of the coated print medium prior to irradiating the first surface.

In yet another example, a printing system can include a printer, a heater, a radiation emitter, and a coated print medium loaded into the printer. The heater can be positioned to heat the coated print medium and the radiation emitter can be positioned to expose a surface of the coated print medium to the radiation. The printer can include a reservoir of a radiation absorbing ink. The ink can include an absorbing agent capable of converting radiation having a wavelength from 200 nm to 400 nm to heat. The printer can also include a printhead in communication with the reservoir to print the ink. The coated print medium can include a print substrate, and an expanding coating layer on the print substrate. The expanding coating layer can include a thermal expansion agent having a minimum expansion temperature. In a certain example, the radiation emitter can be a light emitting diode having a peak wavelength from 265 nm to 400 nm.

In a further example, a printer can include a reservoir of a radiation absorbing ink. The ink can include an absorbing agent capable of converting radiation having a wavelength from 200 nm to 400 nm to heat. The printer can also include an inkjet printhead in communication with the reservoir to print the ink. A media feeder can be positioned to feed a print medium through a print path of the inkjet print head. A radiation emitter having a peak wavelength from 200 nm to 400 nm can be positioned to irradiate the print medium after the ink is printed on the print media. A heater can be positioned to heat the print medium prior to or concurrent with the irradiating of the print medium. In a particular example, the heater and radiation emitter can be static devices which both emit a sufficient width of energy to heat and irradiate, respectively, a width of the print medium when loaded in the printer.

The methods and systems for embossing coated print media described herein can be used to provide easily customizable embossing. Digital printing methods, such as inkjet printing, have allowed for unique and customized printing of images on many substrates. However, there have previously been limited solutions to provide unique and customized texture or embossing in digital printing applications. Additionally, the cost of mechanical embossing equipment can be prohibitive to small scale production of digitally generated content like that typically produced from inkjet printers. Also, the scope of coated substrates that may be mechanically embossed is limited to those possessing the appropriate physical properties, whereas the scope of coated substrates which can currently be printed is greater and growing. Few methods to digitally control texture or embossing of inkjet printed graphics exist, and these can utilize special printers and/or inks that are not universally compatible with current and future inkjet platforms. Herein, a coating design and embossing process is disclosed that will allow digital control of embossing on different substrates for graphics applications. This solution provides compatibility with current and future small and large format inkjet printing platforms without specialty ink formulations.

In some examples, a coated print medium can include an expanding coating layer that can expand in response to an elevated temperature. The medium can be embossed by applying heat to specific areas of the medium, causing the expanding coating to increase in volume in those areas. This can create raised designs on the medium. In some examples, the medium can be heated using electromagnetic radiation. Specifically, radiation having a wavelength from 200 nm to 400 nm can be used in some examples. These wavelengths can be absorbed and converted to heat by a variety of radiation absorbing materials, including some pigments and dyes used in colored inks. The embossed design can therefore be formed, in certain examples, by printing a radiation absorbing material to the medium and then irradiating the medium to selectively heat the medium in the printed areas.

Using radiation in the wavelength band from 200 nm to 400 nm can provide spatial specificity to the embossed patterns, because radiation within this wavelength range is not absorbed at a significant rate by blank print media. Thus, irradiating a print medium having a design printed with an ink that absorbs the radiation can specifically emboss the printed areas while the unprinted areas remain flat and unembossed. However, this process can often consume a large amount of energy to supply sufficient radiation to heat the expanding coating up to the temperature at which the coating will expand. Therefore, embossing using radiation from 200 nm to 400 nm can use a large amount of electrical power and/or a long irradiation time to achieve the embossing.

The efficiency of converting radiative energy in this wavelength band into thermal energy that may be used to increase the volume of an expanding coating is complicated by three general issues. First, these wavelengths are high energy wavelength within the electromagnetic spectrum and inherently will require more electrical energy to produce compared to other light sources. Light emitting diodes (LED's) tailored to specific wavelengths are very efficient compared to their fluorescent counterparts, but there is still room for improvement above the 20-40% efficiency currently in the market. Second, the efficiency of absorption by the ink and/or coating is limited by the amount of radiative energy penetration, with some light being reflected or refracted away from the desired location, as well as the degree of overlap between the wavelength(s) produced by the radiation emitter with the excitation states of the absorbing components. Finally, the dissipation of energy by the excited radiation absorbing components as heat (i.e. kinetic energy) may be reduced by competing processes such as; conversion of a molecular structures into a higher energy state (a chemical reaction/ionization) or emission of some of the energy as lower energy radiation (fluorescence).

Many of the drawbacks associated with heating using radiation in the 200 nm to 400 nm range can be circumvented by using a heater such as an air dryer, oven, infrared oven or lamp to partially heat the print medium. In the case of an oven or dryer, energy is transferred mostly via a kinetic pathway and, consequently, there is less dependency on steps where an energy conversion takes place. In the case of infrared (IR), energy is transferred via radiation, but at a much longer wavelength than 200 nm to 400 nm. The longer wavelength of IR results in interactions with the vibrational motions of matter whereas the 200 nm to 400 nm band interacts with the electronic states of matter. Consequently, IR directly causes heating (i.e. an increase in kinetic energy) when absorbed, and there are no competitive processes like ionization or fluorescence. Furthermore, IR radiation has a greater depth of penetration into matter, resulting in more uniform heating throughout the irradiated material. Ultimately, the mechanism of heating by IR, oven, or dryer is inherently a more energy efficient process than heating by radiation in the 200 nm to 400 nm range.

One advantage of using 200 nm to 400 nm radiation to generate embossing is that the heat is only generated where absorbing agents are deposited by inkjet, and the placement of the absorbing agents provides spatial control of where heat for embossing is generated. This can allow for a customized embossed pattern to be obtained. However, embossing only begins once a minimum expansion temperature is reached. Heating the material to a temperature closer to, but below, the minimum expansion temperature with an oven, dryer, or IR source will reduce the total energy to generate 200 nm to 400 nm radiation to induce the expansion of the expanding coating. Heating the material partially with a complimentary heating source can be more efficient than heating with 200 nm to 400 nm radiation alone, and can increase the overall efficiency of the embossing process. Herein, embossing processes are disclosed in which heaters are used to reduce the amount of radiation used to achieve the temperature required for embossing, thereby increasing productivity and/or reducing the energy requirements of the overall process.

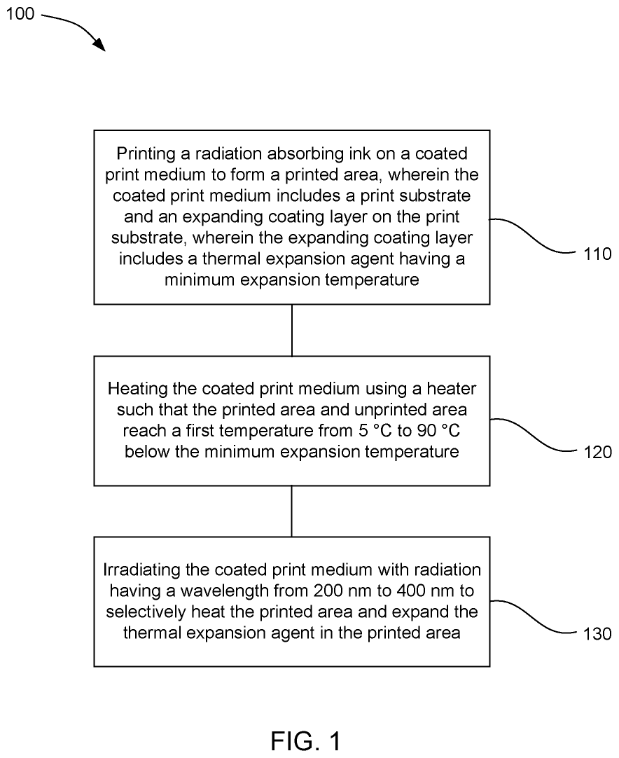

FIG. 1 is a flowchart of an example method 100 of embossing a print medium. The method includes: printing 110 a radiation absorbing ink on a coated print medium to form a printed area, wherein the coated print medium includes a print substrate and an expanding coating layer on the print substrate, wherein the expanding coating layer includes a thermal expansion agent having a minimum expansion temperature; heating 120 the coated print medium using a heater such that the printed area and unprinted area reach a first temperature from 5° C. to 90° C. below the minimum expansion temperature; and irradiating 130 the coated print medium with radiation having a wavelength from 200 nm to 400 nm to selectively heat the printed area and expand the thermal expansion agent in the printed area.

The embossing processes described herein can be enabled by the expanding coating layer on the coated print medium. This layer can include a thermal expansion agent that can expand (i.e., increase in volume) in response to an increase in temperature. In some examples, the thermal expansion agent can have a minimum expansion temperature. Below the minimum expansion temperature, the thermal expansion agent does not expand but retains its original volume.

In some examples, the thermal expansion agent can include temperature responsive thermoplastic beads. These can be small particles made up of a propellant encapsulated in a thermoplastic polymer shell. When the temperature responsive thermoplastic beads are heated to a minimum expansion temperature, the beads can expand due to a combination of softening of the thermoplastic polymer shell and increasing pressure of the propellant. In some examples, the propellant can be a liquid that has a boiling point at or below the minimum expansion temperature.

In further examples, the thermal expansion agent can include a blowing agent dispersed in a polymer coating. In some cases, blowing agents can increase in volume through phase change or chemical decomposition when the blowing agents reach the minimum expansion temperature.

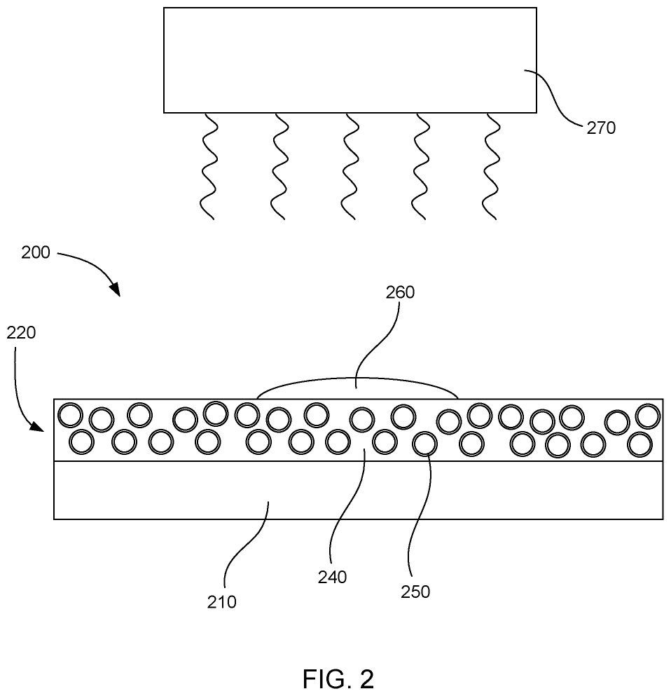

To illustrate the embossing process using 200 nm to 400 nm radiation with a complimentary heat source, FIG. 2 shows an example coated print medium 200. In this example, the coated print medium includes a print substrate 210 and an expanding coating layer 220 on the print substrate. The thermal expansion agent in this example is temperature responsive thermoplastic beads 250. The beads are dispersed in a matrix of a flexible polymeric binder 240. A radiation absorbing ink 260 has been printed on an area of the medium. The radiation absorbing ink can include an absorbing agent capable of converting radiation to heat. In certain examples, the absorbing agent can convert radiation having a wavelength from 200 nm to 400 nm to heat. After printing the ink onto the print medium, the print medium is heated using a heater 270. The heater can evenly heat both the printed area and unprinted area. As mentioned above, the heater can be an oven, a dryer, an IR lamp, or another type of heater that evenly heats the coated print medium. The heater can be used to heat the coated print medium to a temperature from 5° C. to 90° C. below the minimum expansion temperature of the temperature responsive thermoplastic beads.

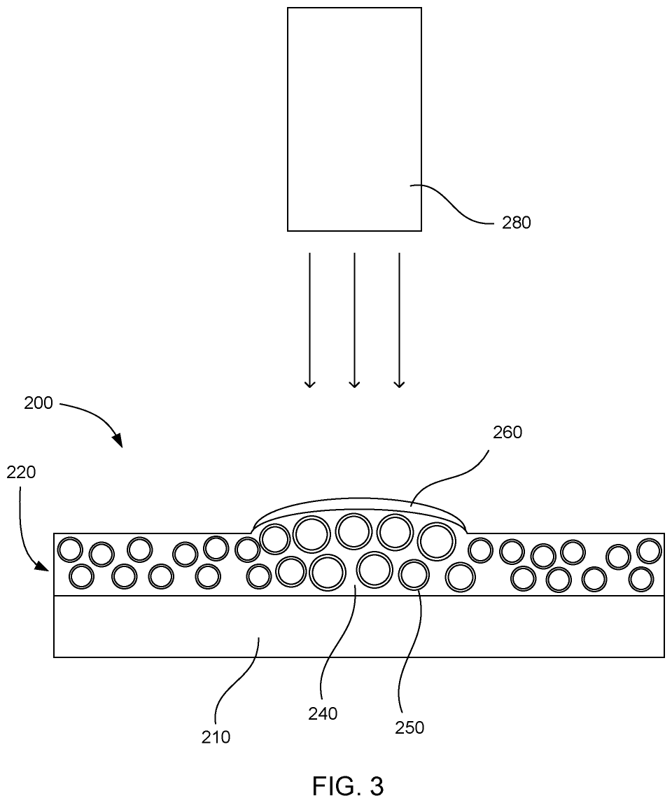

FIG. 3 shows the coated print medium 200 again. After the coated print medium has been heated using a heater, a radiation emitter 280 can irradiate the surface of the coated print medium with radiation having a wavelength from 200 nm to 400 nm. This radiation can be absorbed and converted to heat by the radiation absorbing ink 260 to heat the temperature responsive thermoplastic beads 250 up to the minimum expansion temperature. Thus, the temperature responsive thermoplastic beads expand in the area where the radiation absorbing ink is printed, but not in the unprinted areas. The expansion causes the surface of the coated print medium to rise, creating an embossed design.

In certain examples, the coated print medium can also include an ink receiving layer that can adhere and fix the radiation absorbing ink and any other inks that may be printed on the medium. An ink receiving layer can be applied over the expanding coating layer in some examples. In other examples, an expanding coating layer can be applied to a front surface of the print substrate and an ink receiving layer can be applied to a back surface of the print substrate. In still further examples, ink receiving layers can be applied to both front and back surfaces of the print medium.

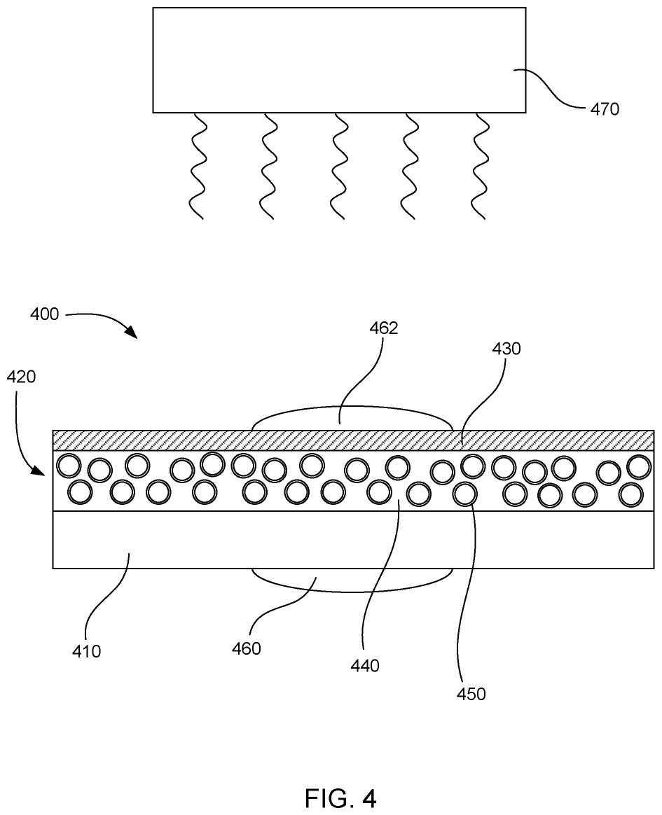

In some examples, the radiation absorbing ink can be a colored ink that is printed on the print medium to form an image. When the medium is irradiated, the areas printed with the colored ink can become embossed as shown in FIG. 3. In other examples, the radiation absorbing ink can be a separate ink that is used along with colored inks. For example, the radiation absorbing ink can be a colorless fluid that can be printed under or over an image formed of colored inks. As used herein, “colored ink” refers to an ink having a color that is visible to the human eye. For example, colored inks can include black inks, cyan inks, magenta inks, yellow inks, and inks of a variety of other visible colors. In still further examples, the radiation absorbing ink can be printed on a back surface of the print medium and then an image can be printed with colored ink on a front surface of the print medium. This arrangement is shown in FIG. 4. In this example, a coated print medium 400 includes a print substrate 410, and expanding coating layer 420, and an ink receiving layer 430. The expanding coating layer includes a flexible polymeric binder 440 and temperature responsive thermoplastic beads 450 in the flexible polymeric binder. The radiation absorbing ink 460 is printed on a back surface of the print medium and a colored ink 462 is printed on a front surface of the print medium. The coated print medium is heated by heater 470. In this example, the heater is positioned above the coated print medium, but in another example the heater can be below the coated print medium.

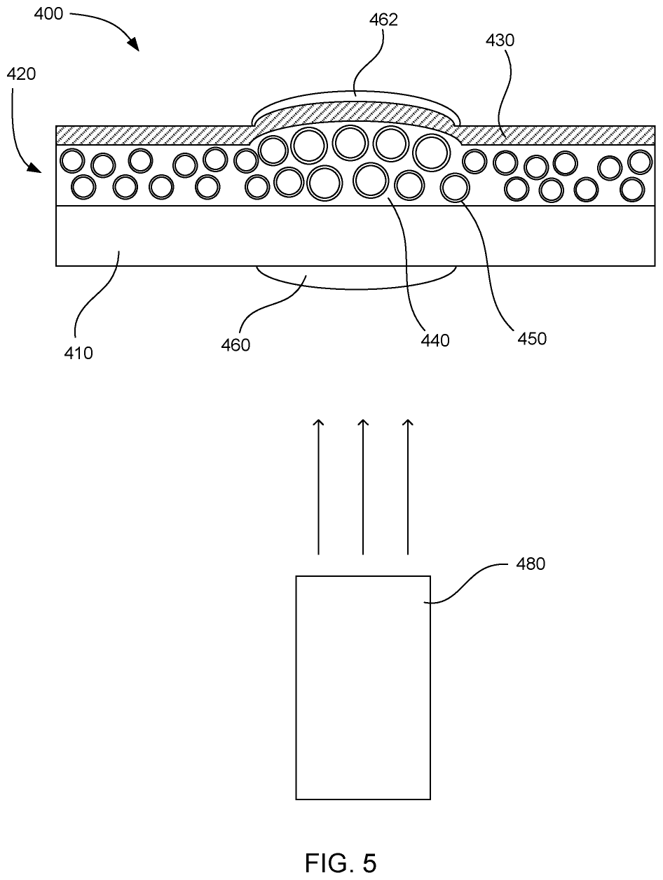

FIG. 5 shows the coated print medium 400 being irradiated with radiation having a wavelength from 200 nm to 400 nm. The radiation emitter 480 is positioned below the coated print medium so that the radiation absorbing ink 460 printed on the back surface of the medium can be irradiated. In this figure, the temperature responsive thermoplastic beads 450 have expanded in the area where the radiation absorbing ink was printed on the back surface of the print medium. In some examples, the radiation can be applied to the surface of the print medium on which the radiation absorbing ink is printed. Thus, when the radiation absorbing ink is printed on the back surface of the print medium, the medium can be irradiated from behind. Similarly, when the radiation absorbing ink is printed on the front surface, the medium can be irradiated from the front.

With this description in mind, in some examples a coated print medium can include a variety of print substrates. In certain examples, the print substrate can include a paper based material. As used herein, “paper” refers to material produced by pressing together moist fibers. This can include paper made of natural fibers, synthetic fibers, or some combination of these. Paper materials can also include fillers, binders, and other additives, as well as any combination thereof.

In further examples, the substrate can include a fabric structure. As used herein, “fabric” can mean a textile, a cloth, a fabric material, fabric clothing, or another fabric product. The term “fabric structure” is intended to mean a structure having warp and weft that can be woven, non-woven, knitted, tufted, crocheted, knotted, and/or pressured, for example. The terms “warp” and “weft” refer to weaving terms that have their ordinary means in the textile arts, as used herein, e.g., warp refers to lengthwise or longitudinal yarns on a loom, while weft refers to crosswise or transverse yarns on a loom. The fabric substrate can include one or both of natural fibers and synthetic fibers.

In still further examples, the print substrate can include a film. The term “film” can refer to any continuous polymeric material that is be extruded or cast. The film can include a polymer material or multiple polymer materials or multiple layers of the same or different polymeric materials or mixtures of polymers. The film can also include fillers and additives which modify its chemical or mechanical properties. A film can also include another material laminated with a polymeric film.

The coated print media described herein can also include an expanding coating layer on the print substrate. In some examples, the expanding coating can include a thermal expansion agent. In certain examples, the thermal expansion agent can be temperature responsive thermoplastic beads which can be incorporated in a flexible polymer matrix. In this case, the term “bead” can be defined as a microparticle including a polymer shell encapsulating a propellant. In some examples, the beads can have an unexpanded average particle size from 2 to 50 microns. In certain examples, the beads can have an unexpanded average particle size from 5 to 15 microns. As used herein, “average particle size” refers to a number average of the diameter of the particles for spherical particles, or a number average of the volume equivalent sphere diameter for non-spherical particles. The volume equivalent sphere diameter is the diameter of a sphere having the same volume as the particle. When the beads are heated, molecular motion of the propellant increases, generating an internal pressure at the core of the beads. Heating can also serve to soften the thermoplastic polymer shell. The combined effect of the polymer shell softening, and increasing internal pressure from the propellant, result in an expansion of the particle diameter. Once the heat is removed the thermoplastic polymer hardens and retains the new diameter. In some examples, the beads can have an expanded diameter from 10 microns to 150 microns. In certain examples, the final diameter of the beads can be influenced by the amount of heating provided. For example, heating the beads to a higher temperature can result in a larger final diameter.

Average particle size can be measured using a particle analyzer such as the Mastersizer™ 3000 available from Malvern Panalytical. The particle analyzer can measure particle size using laser diffraction. A laser beam can pass through a sample of particles and the angular variation in intensity of light scattered by the particles can be measured. Larger particles scatter light at smaller angles, while small particles scatter light at larger angles. The particle analyzer can then analyze the angular scattering data to calculate the size of the particles using the Mie theory of light scattering. The particle size can be reported as a volume equivalent sphere diameter.

In certain examples, the shell of the temperature responsive thermoplastic beads can include a polymer or copolymer material with a glass transition temperature (Tg) from 90° C. to 200° C. In various examples, the polymer(s) can be synthesized from monomers including; vinyl chloride, vinylidene chloride, acrylonitrile, methacrylonitrile, methyl methacrylate, styrene, o-chlorostyrene, vinyl acetate, butyl acrylate, esters of acrylic acid, esters of methacrylic acid, or mixtures thereof.

Glass transition temperature can be measured using differential scanning calorimetry according to ASTM D6604: Standard Practice for Glass Transition Temperatures of Hydrocarbon Resins by Differential Scanning calorimetry. Differential scanning calorimetry can be used to measure the heat capacity of the polymer across a range of temperatures. The heat capacity can jump over a range of temperatures around the glass transition temperature. The glass transition temperature itself can be defined as the temperature where the heat capacity is halfway between the initial heat capacity at the beginning of the jump and the final heat capacity at the end of the jump.

The propellant encapsulated within the shell can be a liquid that can expand or increase pressure inside the shell when heated. In some examples, the propellant can include a liquid which readily evaporates at a boiling point from 90° C. to 200° C. Non-limiting examples of propellants which can be used include hydrocarbons such as methane, ethane, propane, isobutane, n-butane, isooctane, and isopentane, or combinations thereof.

Boiling point can be measured using differential scanning calorimetry. The liquid being tested can be slowly heated through a range of temperatures at a pressure of 1 atm. The heat flow into the liquid (i.e., amount of energy in Joules that is added to the liquid) can be measured and plotted against the temperature of the fluid. When the liquid boils, heat will continuously flow into the liquid without a change in temperature, creating a vertical spike in the plot (with the heat flow on the y-axis and the temperature on the x-axis of the plot). The temperature at which this occurs is the boiling point.

Non-limiting examples of commercial grade temperature responsive thermoplastic beads include; Advancell EM™ EML101™ EML204™, EML301™ EM302™, EML303™, EML304™, EML401™ and other Advencell EM™ products from Sekisui Chemical CO.; Prolite™ 15, Prolite™ 25, Prolite™ 35, Prolite™ 50, and other Prolite™ products from R.J. Marshall CO.; Expancel™ 551 DU 40™, 461DU20™, 461 DU40™, 051 DU40™, 031 DU40™, 053 DU40™, 093 DU 120™, 909 DU80™, 920 DU40™, 920 DU80™, 920 DU120™, 930 DU 120™, 950 DU80™, 951 DU120™, 980 DU120™, and other wet, dry or slurry forms of Expancel™ products from AzkoNobel; expanding polymer beads from Nanosphere; and others.

In some examples, the temperature responsive thermoplastic beads can be present in the expanding coating layer in an amount from 20 wt % to 70 wt % by total dry weight of the expanding coating layer.

The expanding coating layer can also include a flexible polymeric binder. The flexible polymer binder can bind the temperature responsive thermoplastic beads as well as any other additives and fillers that may be in the expanding coating layer. The flexible polymeric binder can also promote adhesion to the substrate and provide adhesion for the image receiving layer. In some examples, the polymeric binder can be present in the expanding coating layer in an amount from 10 wt % to 80 wt % by total dry weight of the expanding coating layer.

In some examples, the polymeric binder can include a water-soluble polymer or an aqueous dispersion such as a latex polymer. In certain examples, the polymer can form a film upon curing. The polymeric binder can include a synthetic polymer, a natural polymer, or a combination thereof. The polymer binder can provide a flexible matrix for the temperature responsive thermoplastic beads, allowing for expansion of the beads without compromising the integrity of the coating. In some cases, the flexible polymeric binder can include an elastomeric polymer with a Tg below that of the thermoplastic shell of the beads. In certain examples, the flexible polymeric binder can have a Tg from −40° C. to 120° C. In further examples, the polymeric binder can have a glass transition temperature (Tg) from −40° C. to 0° C. In other examples, the polymeric binder can have a glass transition temperature (Tg) from −20° C. to −5° C.

In some examples, the flexible polymeric binder can include a cross-linked polymer. As used herein, “crossed-linked” refers to a polymer in which reactive functional groups on the polymer chain have reacted to form structures linking multiple polymer chains together at locations along the length of the chains. In some examples the cross-linking can be formed by adding a cross-linker such as a molecule having two or more functional groups that can react with functional groups on the polymer chains. In other examples, the flexible polymeric binder can include a self-cross-linking polymer that has cross-links formed by direct reaction of functional groups on the polymer chains. In some examples, cross-linked binders can balance elasticity and mechanical strength of the coating layers.

Suitable flexible polymeric binders can include, but are not limited to, polyvinyl alcohol, starch derivatives, gelatin, cellulose derivatives, acrylamide polymers, acrylic polymers or copolymers, vinyl acetate latex, polyesters, vinylidene chloride latex, styrene-butadiene copolymers, acrylonitrile-butadiene copolymers, polyacrylates, polyvinylacetates, polyacrylic acids, polystyrene, polymethacrylates, polyacrylic esters, polymethacrylic esters, polyurethanes, copolymers thereof, and combinations thereof. In certain examples, the binder can be an acrylic polymer or copolymer, vinyl acetate polymer or copolymer, polyester polymer or copolymer, vinylidene chloride polymer or copolymer, butadiene polymer or copolymer, styrene-butadiene polymer or copolymer, or acrylonitrile-butadiene polymer or copolymer. In a further example, the polymeric binder can include an acrylonitrile-butadiene latex.

In further examples, the flexible polymeric binder can include latex particles such as a vinyl acetate-based polymer, an acrylic polymer, a styrene polymer, a styrene-butadiene rubber (SBR)-based polymer, a polyester-based polymer, a vinyl chloride-based polymer, or the like. In yet other examples, the binder can be a copolymer of vinylpyrrolidone. The copolymer of vinylpyrrolidone can include various other copolymerized monomers, such as methyl acrylates, methyl methacrylate, ethyl acrylate, hydroxyethyl acrylate, hydroxyethyl methacrylate, ethylene, vinylacetates, vinylimidazole, vinylpyridine, vinylcaprolactams, methyl vinylether, maleic anhydride, vinylamides, vinylchloride, vinylidene chloride, dimethylaminoethyl methacrylate, acrylamide, methacrylamide, acrylonitrile, styrene, acrylic acid, sodium vinylsulfonate, vinylpropionate, and methyl vinylketone, etc. In still further examples, the flexible polymeric binder can include polyvinyl alcohols or water-soluble copolymers thereof, e.g., copolymers of polyvinyl alcohol and poly(ethylene oxide) or copolymers of polyvinyl alcohol and polyvinylamine; cationic polyvinyl alcohols; aceto-acetylated polyvinyl alcohols; polyvinyl acetates; polyvinyl pyrrolidones including copolymers of polyvinyl pyrrolidone and polyvinyl acetate; gelatin; silyl-modified polyvinyl alcohol; styrene-butadiene copolymer; acrylic polymer latexes; ethylene-vinyl acetate copolymers; polyurethane resin; polyester resin; or combinations thereof. In certain examples, the flexible polymeric binder can include polymerized monomers including vinyl chloride, vinylidene chloride, acrylonitrile, methacrylonitrile, methyl methacrylate, styrene, o-chlorostyrene, vinyl acetate, butyl acrylate, esters of acrylic acid, esters of methacrylic acid, or combinations thereof.

In one example, the flexible polymeric binder can be a polymer having a weight average molecular weight (Mw) of about 5,000 to about 200,000. In another example, the weight average molecular weight of the binder can vary from 10,000 Mw to about 200,000 Mw. In yet another example, the weight average molecular weight of the binder can be from 20,000 Mw to 100,000 Mw. In a further example, the weight average molecular weight of the polymeric binder can be from 100,000 Mw to 200,000 Mw. In one example, the polymeric binder can have a weight average molecular weight from 5,000 Mw to 200,000 Mw and can include polystyrene-butadiene emulsion, acrylonitrile butadiene latex, starch, gelatin, casein, soy protein polymer, carboxy-methyl cellulose, hydroxyethyl cellulose, acrylic emulsion, vinyl acetate emulsion, vinylidene chloride emulsion, polyester emulsion, polyvinyl pyrroilidene, polyvinyl alcohol, styrene butadiene emulsions, or combinations thereof.

In further examples, the thermal expansion agent can be a blowing agent. The blowing agent can be dispersed in a polymer matrix. A blowing agent can be defined as a substance which can be converted from a liquid or solid state into a gas via a phase change or decomposition, respectively. The evolved gas serves to increase the local pressure within the coating of and causes a volume expansion of the material. Substances which may be used include; hydrocarbons such as those listed as propellants above, azodicarbonamide (ADC; 170-200 C), sulfonyl hydrazide's (OBSH, TSH; 143-165 C), benzenesulfonyl hydrazide (BSH; 90-105 C), or any mixture or solution containing these compounds.

The expanding coating layer can also contain other additives and fillers including, but not limited to; whitening agents such as optical brighteners or TiO₂; wetting agents, film formation, and adhesion; dispersants to reduce settling and aggregation of insoluble fillers; de-foaming agents to reduce foam formation, rheology modifiers to reduce settling of fillers; other non-elastomeric binders, adhesives, or plasticizers to modify mechanical properties; fire retardant chemicals; fillers or chemicals which modify the materials thermal properties or thermal transfer characteristics; and so on. In some examples, additives and fillers can be present in the expanding coating layer in an amount from 1 wt % to 50 wt % with respect to the total dry weight of the expanding coating layer.

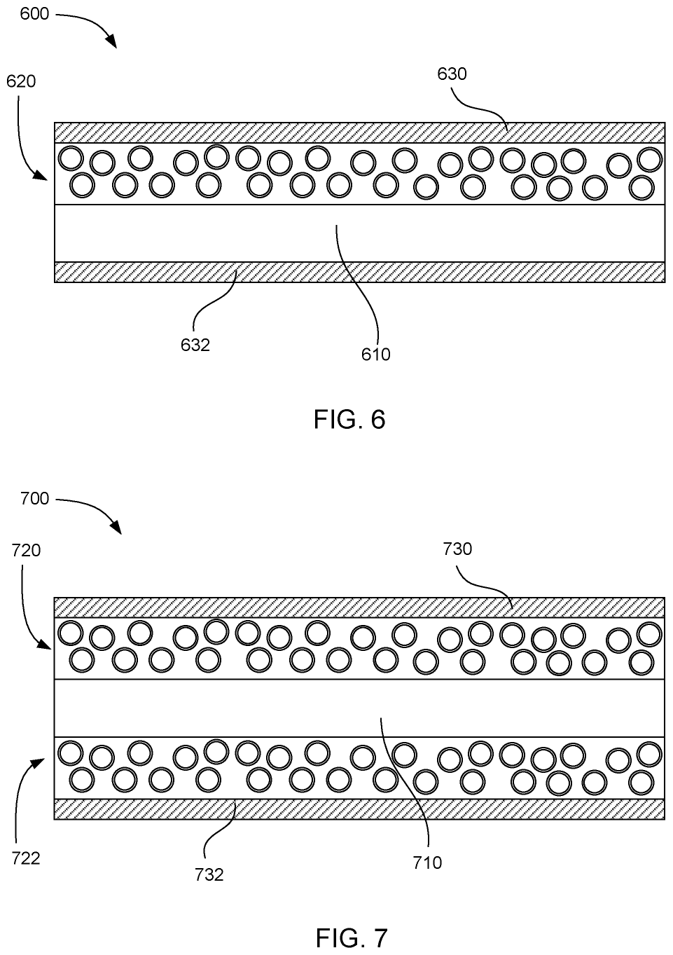

In some examples, an ink receiving layer can be applied over the expanding coating layer. In certain examples, the ink receiving layer can be applied to a front surface of the print medium but not to the back surface. In another example, a second ink receiving layer can be applied to the back surface of the print medium. FIG. 6 shows an example coated print medium 600 that includes a print substrate 610, an expanding coating layer 620 on a front surface of the print substrate, an ink receiving layer 630 on the expanding coating layer, and a second ink receiving layer 632 on a back surface of the print substrate. In this example, a radiation absorbing ink and/or colored ink can be printed on the second ink receiving layer on the back surface of the print medium.

FIG. 7 shows another example coated print medium 700. This example includes a print substrate 710, a first expanding coating layer 720 on a front surface of the print substrate, and a first ink receiving layer 730 on the first expanding coating layer. A second expanding coating layer 722 is on a back surface of the print substrate. A second ink receiving layer 732 is on the second expanding coating layer. In this example, radiation absorbing ink and/or colored ink can be printed on both front and back surfaces of the print medium, and embossed patterns can be formed on both the front and back surfaces by expanding the first and second expanding coating layers.

In some examples, the ink receiving layer can be designed to provide good printing properties for the specific type of ink to be printed on the print medium. In one example, the ink receiving layer can be designed to receive latex-based inks. In some such examples, the ink receiving layer can include a crosslinked polymer network or multiple crosslinked polymer networks that form a continuous film. In some examples, the crosslinked polymer network can have a Tg at or below 120° C., such as from 20° C. to 120° C. In certain examples, the ink receiving layer can include a first crosslinked polymeric network and a second crosslinked polymeric network, both having a glass transition temperature from 20° C. to 120° C. In further examples, the first and second crosslinked polymeric networks can include a polyacrylate, polyurethane, vinyl-urethane, acrylic urethane, polyurethane-acrylic, polyether polyurethane, polyester polyurethane, polycaprolactam polyurethane, polyether polyurethane, alkyl epoxy resin, epoxy novolac resin, polyglycidyl resin, polyoxirane resin, polyamine, styrene maleic anhydride, derivative thereof, or combination thereof. In some examples, the first and second crosslinked polymeric networks can be different polymers.

In one example, the first and/or second crosslinked polymeric network can include a polyacrylate. Polyacrylate-based polymers can include polymers made by hydrophobic addition monomers including, but not limited to, C1-C12 alkyl acrylate and methacrylate (e.g., methyl acrylate, ethyl acrylate, n-propyl acrylate, isopropyl acrylate, n-butyl acrylate, isobutyl acrylate, sec-butyl acrylate, tert-butyl acrylate, 2-ethylhexyl acrylate, octyl arylate, methyl methacrylate, ethyl methacrylate, n-propyl methacrylate, isopropyl methacrylate, n-butyl methacrylate, isobutyl methacrylate, sec-butyl methacrylate, tert-butyl methacrylate), and aromatic monomers (e.g., styrene, phenyl methacrylate, o-tolyl methacrylate, m-tolyl methacrylate, p-tolyl methacrylate, benzyl methacrylate), hydroxyl containing monomers (e.g., hydroxyethylacrylate, hydroxyethylmthacrylate), carboxylic containing monomers (e.g., acrylic acid, methacrylic acid), vinyl ester monomers (e.g., vinyl acetate, vinyl propionate, vinylbenzoate, vinylpivalate, vinyl-2-ethyl hexanoate, vinylversatate), vinyl benzene monomer, C1-C12 alkyl acrylamide and methacrylamide (e.g., t-butyl acrylamide, sec-butyl acrylamide, N,N-dimethylacrylamide), crosslinking monomers (e.g., divinyl benzene, ethyleneglycoldimethacrylate, bis(acryloylamido)methylene), or combinations thereof. Polymers made from the polymerization and/or copolymerization of alkyl acrylate, alkyl methacrylate, vinyl esters, and styrene derivatives can also be used. In one example, the polyacrylate based polymer can include polymers having a glass transition temperature from 20° C. to 120° C. In another example, the polyacrylate based polymer can include polymers having a glass transition temperature from 40° C. to 120° C. In yet another example, the polyacrylate based polymer can include polymers having a glass transition temperature from 50° C. to 120° C.

In one example, the first or second crosslinked polymeric network can include a polyurethane polymer. The polyurethane polymer can be hydrophilic. The polyurethane can be formed in one example by reacting an isocyanate with a polyol. Isocyanates used to form the polyurethane polymer can include toluenediisocyanate, 1,6-hexamethylenediisocyanate, diphenylmethanediisocyanate, 1,3-bis(isocyanatemethyl)cyclohexane, 1,4-cyclohexyldiisocyanate, p-phenylenediisocyanate, 2,2,4(2,4,4)-trimethylhexamethylenediisocyanate, 4,4′-dicychlohexylmethanediisocyanate, 3,3′-dimethyldiphenyl, 4,4′-diisocyanate, m-xylenediisocyanate, tetramethylxylenediisocyanate, 1,5-naphthalenediisocyanate, dimethyltriphenylmethanetetraisocyanate, triphenylmethanetriisocyanate, tris(isocyanatephenyl)thiophosphate, or combinations thereof. Commercially available isocyanates can include Rhodocoat™ WT 2102 (available from Rhodia AG, Germany), Basonat® LR 8878 (available from BASF Corporation, N. America), Desmodur® DA, and Bayhydur® 3100 (Desmodur and Bayhydur available from Bayer AG, Germany). The polyol reacted with the isocyanate can include 1,4-butanediol, 1,3-propanediol, 1,2-ethanediol, 1,2-propanediol, 1,6-hexanediol; 2-methyl-1,3-propanediol, 2,2-dimethyl-1,3-propanediol, neopentyl glycol; cyclohexanedimethanol; 1,2,3-propanetriol, 2-ethyl-2-hydroxymethyl-1,3-propanediol, or combinations thereof. In some examples, the isocyanate and the polyol can have less than three functional end groups per molecule. In another example, the isocyanate and the polyol can have less than five functional end groups per molecule. In yet another example, the polyurethane can be formed from a polyisocyanate having two or more isocyanate functionalities and a polyol having two or more hydroxyl or amine groups.

In a particular example, a polyurethane prepolymer can be prepared with a NCO/OH ratio from 1.2 to 2.2. In another example, the polyurethane prepolymer can be prepared with a NCO/OH ratio from 1.4 to 2.0. In yet another example, the polyurethane prepolymer can be prepared using an NCO/OH ratio from 1.6 to 1.8.

In one example, the weight average molecular weight of the polyurethane prepolymer can range from about 20,000 Mw to about 200,000 Mw as measured by gel permeation chromatography. In another example, the weight average molecular weight of the polyurethane prepolymer can range from about 40,000 Mw to about 180,000 Mw as measured by gel permeation chromatography. In yet another example, the weight average molecular weight of the polyurethane prepolymer can range from about 60,000 Mw to about 140,000 Mw as measured by gel permeation chromatography.

Non-limiting examples of polyurethane polymers can include polyester based polyurethanes, U910™, U938™, U2101™ and U420™; polyether based polyurethane, U205™, U410™, U500™ and U400N™; polycarbonate based polyurethanes, U930™, U933™, U915™ and U911™; castor oil based polyurethane, CUR21™ CUR69™, CUR99™ and CUR991™ and combinations thereof. (All of these polyurethanes are available from Alberdingk Boley Inc., North Carolina).

In some examples the polyurethane can be aliphatic or aromatic. In one example, the polyurethane can include an aromatic polyether polyurethane, an aliphatic polyether polyurethane, an aromatic polyester polyurethane, an aliphatic polyester polyurethane, an aromatic polycaprolactam polyurethane, an aliphatic polycaprolactam polyurethane, or a combination thereof. In another example, the polyurethane can include an aromatic polyether polyurethane, an aliphatic polyether polyurethane, an aromatic polyester polyurethane, an aliphatic polyester polyurethane, or combinations thereof. Commercially-available examples of these polyurethanes can include; NeoPac® R-9000, R-9699, and R-9030 (available from Zeneca Resins, Ohio), Printrite™ DP376 and Sancure® AU4010 (available from Lubrizol Advanced Materials, Inc., Ohio), and Hybridur® 570 (available from Air Products and Chemicals Inc., Pennsylvania), Sancure® 2710, Avalure® UR445 (which are equivalent copolymers of polypropylene glycol, isophorone diisocyanate, and 2,2-dimethylolpropionic acid, having the International Nomenclature Cosmetic Ingredient name “PPG-17/PPG-34/IPDI/DMPA Copolymer”), Sancure® 878, Sancure® 815, Sancure® 1301, Sancure® 2715, Sancure® 2026, Sancure® 1818, Sancure® 853, Sancure® 830, Sancure® 825, Sancure® 776, Sancure® 850, Sancure® 12140, Sancure® 12619, Sancure® 835, Sancure® 843, Sancure® 898, Sancure® 899, Sancure® 1511, Sancure® 1514, Sancure® 1517, Sancure® 1591, Sancure® 2255, Sancure® 2260, Sancure® 2310, Sancure® 2725, Sancure®12471, (all commercially available from available from Lubrizol Advanced Materials, Inc., Ohio), or combinations thereof.

In some examples, the polyurethane can be cross-linked using a cross-linking agent. In example, the cross-linking agent can be a blocked polyisocyanate. In another example, the blocked polyisocyanate can be blocked using polyalkylene oxide units. In some examples, the blocking units on the blocked polyisocyanate can be removed by heating the blocked polyisocyanate to a temperature at or above the deblocking temperature of the blocked polyisocyanate in order to yield free isocyanate groups. An example blocked polyisocyanate can include Bayhydur® VP LS 2306 (available from Bayer AG, Germany). In another example, the crosslinking can occur at trimethyloxysilane groups along the polyurethane chain. Hydrolysis can cause the trimethyloxysilane groups to crosslink and form a silesquioxane structure. In another example, the crosslinking can occur at acrylic functional groups along the polyurethane chain. Nucleophilic addition to an acrylate group by an acetoacetoxy functional group can allow for crosslinking on polyurethanes including acrylic functional groups. In other examples the polyurethane polymer can be a self-crosslinked polyurethane. Self-crosslinked polyurethanes can be formed, in one example, by reacting an isocyanate with a polyol.

In another example, the first or second crosslinked polymeric network can include an epoxy. The epoxy can be an alkyl epoxy resin, an alkyl aromatic epoxy resin, an aromatic epoxy resin, epoxy novolac resins, epoxy resin derivatives, and combinations thereof. In some examples, the epoxy can include an epoxy functional resin having one, two, three, or more pendant epoxy moieties. Example epoxy functional resins can include Ancarez® AR555 (commercially available from Air Products and Chemicals Inc., Pennsylvania), Ancarez® AR550, Epi-rez™ 3510W60, Epi-rez™ 3515W6, Epi-rez™ 3522W60 (all commercially available from Hexion, Texas) and combinations thereof. In some examples, the epoxy resin can be an aqueous dispersion of an epoxy resin. Example commercially available aqueous dispersions of epoxy resins can include Araldite® PZ3901, Araldite® PZ3921, Araldite® PZ3961-1, Araldite® PZ323 (commercially available from Huntsman International LLC, Texas), Waterpoxy® 1422 (commercially available from BASF, Germany), Ancarez® AR555 1422 (commercially available from Air Products and Chemicals, Inc., Pennsylvania), and combinations thereof. In yet another example, the epoxy resin can include a polyglycidyl or polyoxirane resin.

In one example, the epoxy resin can be self-crosslinked. Self-crosslinked epoxy resins can include polyglycidyl resins, polyoxirane resins, and combinations thereof. Polyglycidyl and polyoxirane resins can be self-crosslinked by a catalytic homopolymerization reaction of the oxirane functional group or by reacting with co-reactants such as polyfunctional amines, acids, acid anhydrides, phenols, alcohols, and/or thiols.

In other examples, the epoxy resin can be crosslinked by an epoxy resin hardener. Epoxy resin hardeners can be included in solid form, in a water emulsion, and/or in a solvent emulsion. The epoxy resins hardener, in one example, can include liquid aliphatic amine hardeners, cycloaliphatic amine hardeners, amine adducts, amine adducts with alcohols, amine adducts with phenols, amine adducts with alcohols and phenols, amine adducts with emulsifiers, ammine adducts with alcohols and emulsifiers, polyamines, polyfunctional polyamines, acids, acid anhydrides, phenols, alcohols, thiols, and combinations thereof. Example commercially available epoxy resin hardeners can include Anquawhite™ 100 (commercially available from Air Products and Chemicals Inc., Pennsylvania), Aradur® 3985 (commercially available from Huntsman International LLC, Texas), Epikure™ 8290-Y-60 (commercially available from Hexion, Texas), and combinations thereof.

In one example, the first or second crosslinked polymeric network can include an epoxy resin and the epoxy resin can include a water based epoxy resin and a water based polyamine. In another example, the first or second crosslinked polymeric network can include a vinyl urethane hybrid polymer, a water based epoxy resin, and a water based polyamine epoxy resin hardener. In yet another example, the first or second crosslinked polymeric network can include an acrylic-urethane hybrid polymer, a water based epoxy resin, and a water based polyamine epoxy resin hardener.

In some examples, the first crosslinked polymeric network can be crosslinked to itself. In another example, the first crosslinked polymeric network can be crosslinked to itself and to the second crosslinked polymeric network. In one example, the second crosslinked polymeric network can be crosslinked to itself. When the first crosslinked polymeric network and the second crosslinked polymeric network are not crosslinked to one another they can be entangled or appear layered onto one another.

The first and second crosslinked polymeric networks can be present in the image receiving layer in a variety of amounts. In one example, the first and second crosslinked polymeric networks can collectively make up from about 80 wt % to about 99 wt % of the ink receiving layer. In another example, the first and second crosslinked polymeric networks can collectively make up about 80 wt % to about 97 wt % of the ink receiving layer. In yet another example, the first and second crosslinked polymeric networks can collectively make up from about 85 wt % to about 95 wt % of the ink receiving layer. In a further example, the first and second crosslinked polymeric networks can collectively make up from about 85 wt % to about 93 wt % of the secondary coating layer. In some examples the first and second crosslinked polymeric networks can be present in equal amounts. In other examples the first and second crosslinked polymeric networks can be present in different amounts.

In some examples, the process of applying the ink receiving layer can include a floating knife process, a knife on roll mechanism process, or a transfer coating process.

Ink receiving layers designed for latex ink can also contain other additives and fillers including but not limited to; waxes to increase durability; whitening agents such as optical brighteners or TiO₂; wetting agents, film formation, and adhesion; dispersants to reduce settling and aggregation of insoluble fillers; de-foaming agents to reduce foam formation, rheology modifiers to reduce settling of fillers; other non-elastomeric binders, adhesives, or plasticizers to modify mechanical properties; fire retardant chemicals; physical or chemical absorbing agents which modify the materials thermal properties or radiative absorption; and so on.

In one example, the image receiving layer can be applied to the substrate at a dry coat weight of from 1 gsm to 30 gsm. In another example, the dry coat weight can be from 1 gsm to 20 gsm. The filler amounts can range from 10% to 80% of the dry mass. In another example, the filler amount can be from 10% to 50%.

For dye or pigmented inks which do not contain latex, the ink receiving layer composition can include a porous coating with components that impart gloss and durability while maintaining image quality. This can include silica or alumina pigment dispersions chemically treated to increase image quality and dispersion stability. The treatments can include pH modifiers and small molecules to modify the pigment surface. The ink receiving layer can also include wetting agents, de-foaming agents, and rheology modifiers to increase coating adherence and uniformity. The ink receiving layer can also include binders such as polyacrylates, polyvinyl alcohols, resins, polyols, and so on. The ink receiving layer can also include natural or synthetic elastomers such as styrene butadiene, natural rubbers, polyurethanes, neoprenes, polyisoprenes, polyacrylates, and so on, with a Tg below 120° C. to impart flexibility, coating durability, and coating uniformity to the embossed image. In some cases, the ink receiving layer can also include physical or chemical absorbing agents which modify the thermal properties or radiative absorption of the ink receiving layer.

As mentioned above, in some examples the coated print medium can be heated to a temperature from 5° C. to 90° C. below the minimum expansion temperature. This can be accomplished by a heater than can evenly heat the coated print medium, including areas printed with radiation absorbing ink and unprinted areas. In some examples, the heater can include a dryer or oven. As used herein, a “dryer” or “oven” may refer to any heating apparatus that transfers heat to the material via conduction or convection. In this case the source of heat for such an apparatus may be in the form of electrical energy that produces heat via passing current through a resistive material. Alternatively, the source of heat may come from combustion of a flammable material including, but not limited to; methane, natural gas, gasoline or other volatile hydrocarbons, etc. In some examples, the dryer or oven can be placed to heat the coated print medium immediately prior to irradiation with 200 nm to 400 nm radiation, and minimize the loss of heat which may occur between these heating processes. In certain examples, the dryer already incorporated into many commercial printers can be used as the heating source which compliments the irradiation. In other examples, the expansion process may occur outside of the printer via a standalone dryer/oven and radiation emitter.

In other examples, the heater can include an IR source such as an IR lamp, an array of IR lamps, or an IR oven. In some examples, the IR source can be placed immediately prior to the radiation emitter, in a similar manner to that described for a dryer or oven. Also, the IR source may be a standalone component or a component already existing in commercially available printing technologies. In yet other examples, the IR source and radiation emitter may be incorporated into a single unit, or any configuration by which the coated print medium may be irradiated with both IR and 200 nm to 400 nm band radiation simultaneously. For example, an IR source can be located on one side of the coated print medium and the radiation emitter can be located on the opposite side of the medium. In a specific example, an IR source can be located above the coated print medium and the radiation emitter can be located below the medium. The IR source can be located to heat the coated print medium at the same time as the radiation emitter irradiates the opposite side.

In some cases, the expanding coating layer can be used for enhancing the appearance of graphic images by producing an embossed effect at desired locations. In this application the thermal treatment via irradiation and the alternate heating source used to cause embossing can occur either before or after the visible image is printed. For example, a visible image can be printed using colored ink on the coated print medium. A radiation absorbing ink can be printed either on the same side of the medium as the visible image, or on the opposite side. The coated print medium can then be heated using the heater and a radiation emitter can selectively heat the areas printed with the radiation absorbing ink to form an embossed pattern. In alternative examples, the embossed pattern can be formed before printing a visible image. The visible image can then be printed over the embossed pattern by printing colored ink onto the embossed medium.

In some examples, an IR source and a 200 nm to 400 nm radiation emitter can be set up in an array or scanning configuration. The term “array” refers to the placement of multiple radiation sources in a stationary configuration which allows the full width of the print medium to be irradiated at once while the print medium is moving under the array. The term “scanning” refers to the placement of radiation sources which move across the full width of the print medium while the print medium is stationary or moving. In certain examples, the radiation emitter and/or IR source can be located in a carriage together with an inkjet printhead to print the radiation absorbing ink or colored ink.

The temperature to which the complimentary heater heats the coated print medium can be below the minimum expansion temperature of the thermal expansion agent in the expanding coating layer. In various examples, the heating temperature can be from 5° C. to 90° C. below the minimum expansion temperature. For example, if the heater heats the print medium prior to the radiation emitter irradiating the print medium, then the entire print medium can be heated to a temperature that is 5° C. to 90° C. below the minimum expansion temperature prior to irradiation and then the irradiation can selectively heat the areas printed with radiation absorbing ink up to the minimum expansion temperature or higher. In examples where the heating and irradiation are performed simultaneously, the heater can heat unprinted areas up to a temperature from 5° C. to 90° C. below the minimum expansion temperature while the irradiation selectively heats the areas printed with radiation absorbing ink up to the minimum expansion temperature or higher. The precise heating temperature can be selected to optimize the energy efficiency of the entire embossing process while also ensuring that no unintended embossing occurs outside the areas printed with radiation absorbing ink. In certain examples, the heating temperature provided by the heater can be from 20° C. to 180° C.

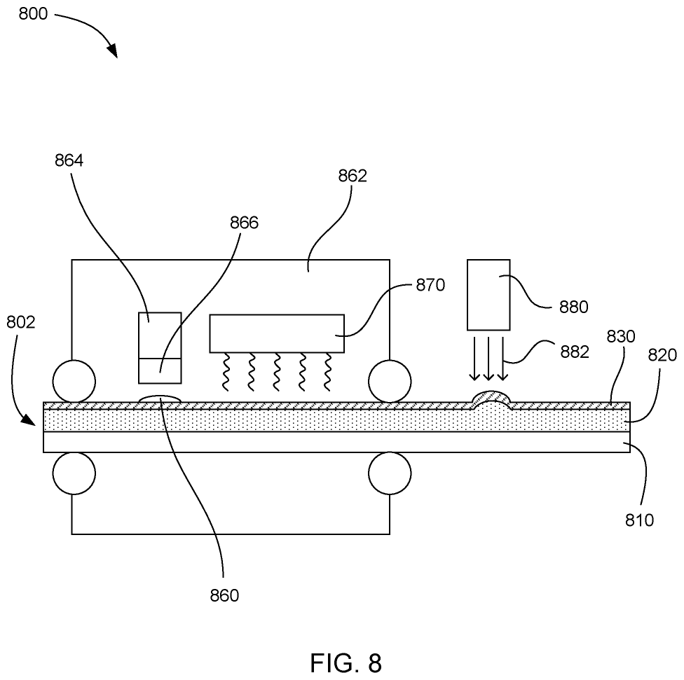

The present disclosure also extends to printing systems that use the coated print media described above. FIG. 8 shows an example printing system 800. The system includes a printer 862. The printer has a reservoir 864 of radiation absorbing ink 860, where the ink includes an absorbing agent capable of converting radiation having a wavelength from 200 nm to 400 nm to heat. The printer also has a printhead 866 in communication with the reservoir to print the ink. The system further includes an IR lamp 870 for heating, a radiation emitter 880 having a peak wavelength from 200 nm to 400 nm, and a coated print medium 802 to load in the printer. The radiation emitter is positioned to expose a surface of the coated print medium to radiation 882 after the radiation absorbing ink is printed on the coated print medium. The coated print medium includes a print substrate 810, an expanding coating layer 820 on the print substrate, and an ink receiving layer 830 on the expanding coating layer.

In some examples, the printhead and the radiation emitter can both be located on the same side of the print medium. That is, if the printhead is positioned to print radiation absorbing ink on a front surface of the print medium then the radiation emitter can be positioned to irradiate the front surface. If the printhead is positioned to print radiation absorbing ink on a back surface of the print medium then the radiation emitter can be positioned to irradiate the back surface. In some examples, the radiation absorbing ink can be a colored ink and the printhead can be positioned to print the colored ink on the front surface of the print medium. In other examples, the printer can include separate printheads for the radiation absorbing ink and for colored inks. The radiation absorbing ink can be printed on the back surface of the print medium and the colored inks can be printed on the front surface of the print medium. In this example, the radiation emitter can be positioned to irradiate the back surface of the print medium. In further examples, the printer can be designed for duplex printing and the coated print medium can include two expanding coating layers and two ink receiving layers, one on either side of the medium. In this example, the printer can include two radiation absorbing ink printheads on either side of the print medium and two radiation emitters can be used to irradiate both sides of the print medium.

In certain examples, the radiation emitter and/or heater can be separate components from the printer. For example, in roll-to-roll printing systems, a continuous roll, or web, of coated print medium can travel past a printer first, followed by a heater and radiation emitter. In other examples, the radiation emitter and/or heater can be integrated as a part of the printer. In some examples, the printer can be designed to print on individual sheets of print media. This configuration may be used in printers for the home or office. Such a printer can include the printhead for printing radiation absorbing ink, the heater for heating the print media, and the radiation emitter for embossing the surface of the print media.

In some examples, the radiation absorbing ink can be a colored ink. Colored inks can include colorants such as dyes or pigments in a variety colors. Colored inks can include black ink, cyan ink, magenta ink, yellow ink, and a variety of other colored inks. In further examples, the radiation absorbing ink can be a colorless ink that can be printed along with colored inks, either on the same front surface of the print medium with the colored inks or on a back surface of the print medium. In some examples the absorbing agent in the ink can include carbon black, titanium dioxide, colored pigments or dyes, conjugated small molecules or polymers, bisoctrizole, avobenzone, bisdisulizole disodium, diethylamino hydroxybenzoyl hexyl benzoate, a benzotriazole, a benzophenone, a triazine, other optical brighteners, or combinations thereof.

Other ingredients in the radiation absorbing ink can include a liquid vehicle, a colorant, a binder, a surfactant, additives to inhibit the growth of microorganisms, viscosity modifiers, materials for pH adjustment, sequestering agents, anti-kogation agents, preservatives, and the like. In some examples, the liquid vehicle can be an aqueous liquid vehicle that includes water and optionally a co-solvent. In further examples, the binder can include a polyurethane or a film-forming latex.

The radiation emitter can include a lamp, laser, or array of LED's. In some examples, the radiation emitter can produce a minimum peak irradiance of 10 W/cm² at the embossing surface. Greater irradiance can be helpful to control emission energy and production speed to reduce potential hazards. In certain examples, the radiation emitter can be a lamp that produces wavelengths between 200-400 nm. The minimum irradiance of 10 W/cm² can occur at a wavelength that overlaps with the absorption peak of the printed radiation absorbing ink. Examples of lamps that can be used include, but are not limited to, gas discharge lamps such as mercury, iron iodide, or gallium iodide or a combination of these that are excited by an electric arc or microwave radiation. Commercially available lamps of this type can include the AMBA® & Light Hammer™ product lines available from Heraeus Inc.

In other examples the radiation emitter can include an array of LEDs. Again, the minimum peak irradiance at the material surface can be no less than 10 W/cm², and the peak irradiance wavelength of the radiation emitter can overlap with the absorption spectrum of the radiation absorbing ink. In one example, the peak wavelength of the LEDs and the peak absorption wavelength of the radiation absorbing ink can be from 200 nm to 400 nm. In certain examples, the LEDs can have a peak wavelength from 365 nm to 400 nm. Examples of useful LED systems include, but are not limited to; FireJet™ FJ100, FireJet™ FJ200, FireJet™ FL400, FirePower™ FP300, etc. from Phoseon Technology Inc. Many of these systems have a peak irradiance greater than 10 W/cm², at wavelengths including, but not limited to 365 nm, 385 nm, and 395 nm.

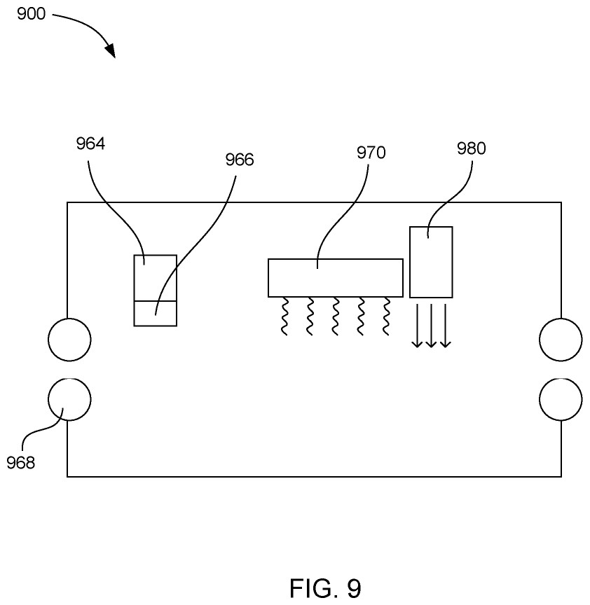

The present disclosure also extends to printers that can be used to print and emboss according to the process described herein. FIG. 9 shows an example printer 900 that includes a reservoir 964 of a radiation absorbing ink. The radiation absorbing ink can include an absorbing agent capable of converting radiation having a wavelength from 200 nm to 400 nm to heat. An inkjet printhead 966 can be in communication with the reservoir to print the ink. A media feeder 968 can be positioned to feed a print medium through a print path of the inkjet print head. A radiation emitter 980 having a peak wavelength from 200 nm to 400 nm can be positioned to irradiate the print medium after the ink is printed on the print medium. A heater 970 can be positioned to heat the print medium. In this example, the heater is positioned to heat the print medium immediately prior to the radiation emitter irradiating the print medium. In other examples, the heater can be positioned to heat the print medium simultaneously with the radiation emitter irradiating the print medium.

In some examples, the heater and radiation emitter can be static devices that do not move across the surface of the print medium. The print medium can be fed past the heater and the radiation emitter, and the heater and radiation emitter can have a sufficient width that they can heat and irradiate the entire width of the print medium passing by. In examples where the heater or radiation emitter are not physically as wide as the print medium, they can still emit a sufficient width of energy (i.e., heat or radiation) that they can heat and irradiate, respectively, the width of the print medium. In alternative examples, the heater and/or radiation emitter can be moveable and can move along the width of the print medium.

It is noted that, as used in this specification and the appended claims, the singular forms “a,” “an,” and “the” include plural referents unless the content clearly dictates otherwise.

As used herein, the term “about” is used to provide flexibility to a numerical range endpoint by providing that a given value may be “a little above” or “a little below” the endpoint. The degree of flexibility of this term can be dictated by the particular variable and can be determined based on experience and the associated description herein.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, dimensions, amounts, and other numerical data may be presented herein in a range format. It is to be understood that such range format is used merely for convenience and brevity and should be interpreted flexibly to include the numerical values explicitly recited as the limits of the range, and also to include all the individual numerical values or sub-ranges encompassed within that range as if each numerical value and sub-range is explicitly recited. For example, a weight ratio range of about 1 wt % to about 20 wt % should be interpreted to include the explicitly recited limits of 1 wt % and about 20 wt %, and also to include individual weights such as 2 wt %, 11 wt %, 14 wt %, and sub-ranges such as 10 wt % to 20 wt %, 5 wt % to 15 wt %, etc.

As a further note, in the present disclosure, it is noted that when discussing the print media, methods, and systems described herein, each of these discussions can be considered applicable to each of these examples, whether or not they are explicitly discussed in the context of that example. Thus, for example, in discussing details about the print media, such discussion also refers to the methods and systems, and vice versa.

### Examples

A series of coated print media sheets were made, printed, embossed, and tested using the compositions and tests described below. Table 1 shows compositions of four different expanding coating layers and one ink receiving layer composition that were used in the coated print media sheets.

TABLE 1
Coating Compositions (“ECL” = Expanding Coating Layer;
“IRL” = Ink Receiving Layer)

| Ingredient | Ingredient Type | ECL 1 | ECL 2 | ECL 3 | ECL 4 | IRL |
|---|---|---|---|---|---|---|
| 960 DU 120 ™ | Expanding Beads | 40 | 40 | 40 | 40 | |
| Aerosol ™ TR-70 | Dispersant | | 0.5 | 2 | | |
| DisperBYK ® 191 | Dispersant | | | | 5 | |
| BYK 018 ™ | Defoamer | 0.5 | 0.5 | 0.5 | 0.5 | |
| Styrene Butadiene | Latex | 57 | 56 | 55 | 52 | |
| Dynwet ™ 800 | Wetting Agent | 1 | 1 | 1 | 1 | 1 |
| Mowiol ™ 6-98 | PVOH/thickener | 2 | 2 | 2 | 2 | |
| Tylose | thickener | | | | | 1 |
| Sancure ™ 2026 | Latex | | | | | 25 |
| Sancure ™ AU 4010 | Latex | | | | | 25 |
| Ancarez ™ AR 555 | Epoxy | | | | | 25 |
| Anquawhite ™ 100 | Crosslinker | | | | | 23 |
| Total Parts | | 100 | 100 | 100 | 100 | 100 |

960 DU 120 ™ is available from AkzoNobel; Aerosol ® TR-70 is available from Cytec; DisperBYK ® 191 is available from BYK; BYK 018 ™ is available from BYK; Dynwet ™ 800 is available from BYK; Mowiol ™ 6-98 is available from Kuraray; Sancure ™ 2026 is available from Lubrizol; Sancure ™ AU 4010 is available from Lubrizol; Ancarez ™ AR 555 is available from Evonik; Anquawhite ™ 100 is available from Evonik.

The coatings were applied to print substrates at a target coat weight of 40 gsm (grams per square meter) for the expanding coating layer and 10 gsm for the ink receiving layer using a hand blade at a viscosity of 6000 cP (centipoise). The samples were then printed using HP Latex 360® large format printers and embossing was tested with or without oven pretreatment at 95° C. for 15 min. Embossing was performed by exposing the samples to radiation from a Phoseon FirePower™ 300 UV LED lamp. Table 2 shows the samples and the results of embossing tests with and without the oven pretreatment. The embossing height was calculated by subtracting the thickness of unembossed areas from the thickness of embossed areas of the samples, as measured using a caliper.

TABLE 2

| | | | Oven | Radiation | Embossing |
|---|---|---|---|---|---|
| Sample | | Print | Temp | dose | Height |
| # | ECL | Substrate | (° C.) | (mJ/cm²) | (mm) |
| 1 | ECL 1 | Wallpaper | — | 22696 | .05 |
| 2 | ECL 1 | Wallpaper | 95 | 5674 | .05 |
| 3 | ECL 2 | Wallpaper | — | 22696 | .14 |
| 4 | ECL 2 | Wallpaper | 95 | 5674 | .12 |
| 5 | ECL 3 | Wallpaper | — | 22696 | .17 |
| 6 | ECL 3 | Wallpaper | 95 | 5674 | .17 |

A similar test was performed for samples based on a polyester textile substrate. The expanding coating layer and the ink receiving layer were applied to a polyester textile and embossed with and without oven pretreatment. Table 3 shows the results of these tests.

TABLE 3

| | | | Oven | Radiation | Avg. Embossing |
|---|---|---|---|---|---|
| Sample | | Print | Temp | dose | Height |
| # | ECL | Substrate | (° C.) | (mJ/cm²) | (mm) |
| 1 | ECL 1 | Textile | — | 11348 | .15 |
| 2 | ECL 1 | Textile | 95 | 5674 | .15 |
| 3 | ECL 2 | Textile | — | 11348 | .17 |
| 4 | ECL 2 | Textile | 95 | 5674 | .18 |

Similar tests were again performed with samples based on a brochure paper substrate. The expanding coating layer and ink receiving layer were applied to a brochure paper substrate and the embossing was tested with and without the oven pretreatment. Table 4 shows the results of these tests.

TABLE 4

| | | | Oven | Radiation | Avg. Embossing |
|---|---|---|---|---|---|
| Sample | | Print | Temp | dose | Height |
| # | ECL | Substrate | (° C.) | (mJ/cm²) | (mm) |
| 1 | ECL 1 | Brochure | — | 11348 | .17 |
| 2 | ECL 1 | Brochure | 95 | 5674 | .14 |
| 3 | ECL 1 | Brochure | 95 | 3783 | .10 |
| 4 | ECL 2 | Brochure | — | 11348 | .15 |
| 5 | ECL 2 | Brochure | 95 | 5674 | .12 |
| 6 | ECL 2 | Brochure | 95 | 3783 | .08 |
| 7 | ECL 3 | Brochure | — | 11348 | .19 |
| 8 | ECL 3 | Brochure | 95 | 5674 | .14 |
| 9 | ECL 3 | Brochure | 95 | 3783 | .10 |
| 10 | ECL 4 | Brochure | — | 11348 | .21 |
| 11 | ECL 4 | Brochure | 95 | 5674 | .23 |
| 12 | ECL 4 | Brochure | 95 | 3783 | .11 |

The test results show that preheating the media can allow for embossing with a lower dose of radiation. Tables 2-4 show that, depending on the type of substrate, preheating embossable media can reduce the radiation dosage to emboss the media by 2 to 4 times while yielding a similar embossing height.

While the disclosure has been described with reference to certain examples, various modifications, changes, omissions, and substitutions can be made without departing from the spirit of the disclosure. It is intended, therefore, that the disclosure be limited by the scope of the following claims.

What is claimed is:

1. A method of radiative embossing a print medium, comprising:
printing a radiation absorbing ink on a coated print medium to form a printed area, wherein the coated print medium comprises:
a print substrate, and
an expanding coating layer on the print substrate, wherein the expanding coating layer comprises a thermal expansion agent having a minimum expansion temperature;
heating the coated print medium using a heater such that the printed area and unprinted area reach a first temperature from 5° C. to 90° C. below the minimum expansion temperature; and
irradiating the coated print medium with radiation having a wavelength from 200 nm to 400 nm to selectively heat the printed area and expand the thermal expansion agent in the printed area.

2. The method of claim 1, wherein the coated print medium further comprises an ink receiving layer on the expanding coating layer.

3. The method of claim 1, wherein the radiation absorbing ink comprises an absorbing agent including a cyan colorant, a magenta colorant, a yellow colorant, bisoctrizole, avobenzone, bisdisulizole disodium, diethylamino hydroxybenzoyl hexyl benzoate, a benzotriazole, a benzophenone, a triazine, or combinations thereof.

4. The method of claim 1, wherein the expanding coating layer further comprises a flexible polymeric binder and the thermal expansion agent comprises temperature responsive thermoplastic beads in the flexible polymeric binder, wherein the temperature responsive thermoplastic beads comprise a propellant encapsulated in a thermoplastic polymer shell

5. The method of claim 4, wherein the thermoplastic polymer shell has a glass transition temperature from 90° C. to 200° C.

6. The method of claim 4, wherein the flexible polymeric binder has a glass transition temperature below a glass transition temperature of the thermoplastic polymer shell.

7. The method of claim 6, wherein the glass transition temperature of the flexible polymeric binder is from −40° C. to 120° C.

8. The method of claim 1, wherein the flexible polymeric binder includes styrene butadiene latex, acrylic latex, or a polymer comprising polymerized monomers including vinyl chloride, vinylidene chloride, acrylonitrile, methacrylonitrile, methyl methacrylate, styrene, o-chlorostyrene, vinyl acetate, butyl acrylate, esters of acrylic acid, esters of methacrylic acid, or combinations thereof.

9. The method of claim 1, wherein the propellant is a liquid having a boiling point from 90° C. to 200° C.

10. The method of claim 1, wherein the propellant includes methane, ethane, propane, isobutane, n-butane, isooctane, and isopentane, or combinations thereof.

11. The method of claim 1, wherein the radiation absorbing ink is printed on a first surface of the coated print medium and the first surface is irradiated with the radiation having a wavelength from 200 nm to 400 nm to expand the thermal expansion agent in the printed area, and wherein the method further comprises printing a visible image on an opposite surface of the coated print medium prior to irradiating the first surface.

12. A radiative embossing printing system, comprising:
a printer, comprising:
a reservoir of a radiation absorbing ink, wherein the ink comprises an absorbing agent capable of converting radiation having a wavelength from 200 nm to 400 nm to heat, and
a printhead in communication with the reservoir to print the ink,
a heater;
a radiation emitter; and
a coated print medium loaded in the printer, wherein the heater is positioned to heat the coated print medium and the radiation emitter is positioned to expose a surface of the coated print medium to the radiation, and wherein the coated print medium comprises:
a print substrate, and
an expanding coating layer on the print substrate, wherein the expanding coating layer comprises a thermal expansion agent having a minimum expansion temperature.

13. The system of claim 12, wherein the radiation emitter is a light emitting diode having a peak wavelength from 265 nm to 400 nm.

14. A radiative embossing printer, comprising:
a reservoir of a radiation absorbing ink, wherein the ink comprises an absorbing agent capable of converting radiation having a wavelength from 200 nm to 400 nm to heat;
an inkjet printhead in communication with the reservoir to print the ink;
a media feeder positioned to feed a print medium through a print path of the inkjet print head;
a radiation emitter having a peak wavelength from 200 nm to 400 nm positioned to irradiate the print medium after the ink is printed on the print medium; and
a heater positioned to heat the print medium prior to or concurrent with the irradiating of the print medium.

15. The printer of claim 14, wherein the heater and radiation emitter are static devices which both emit a sufficient width of energy to heat and irradiate, respectively, a width of the print medium when loaded in the printer.
